(19) United States
(12) Patent Application Publication
(10) Pub. No.: US 2026/0161638 A1
(43) Pub. Date: Jun. 11, 2026

(54) BULK SELECTION FOR DATA MANAGEMENT

(71) Applicant: Rubrik, Inc., Palo Alto, CA (US)

(72) Inventors: Binan Zhang, San Jose, CA (US); Catherine Utah, Crozet, VA (US); Michael Negley Abernethy, JR., Round Rock, TX (US); Mukul Chandra Singh Bisht, Saratoga, CA (US); Xiaoyang Zhao, Fremont, CA (US); Oded Klimer, San Jose, CA (US)

(21) Appl. No.: 18/972,627

(22) Filed: Dec. 6, 2024

(51) Int. Cl. G06F 16/23; G06F 16/242; G06F 16/2455

(52) U.S. Cl. CPC G06F 16/2386; G06F 16/2423; G06F 16/24552

(57) ABSTRACT

Methods, systems, and devices for data management are described. The described techniques may enable a user of a data management system (DMS) to select data objects and perform actions on all selected data objects. A front-end of the DMS may include one or more components for interfacing with the user. In response to a user request to select all objects of a set, the DMS may load the set of data objects into a cache of the front-end. If the set has less than a threshold quantity of data objects, the DMS may load all data objects of the set into the cache. If the set has more than a threshold quantity of data objects, the DMS may iteratively load subsets of the set having less than the threshold quantity of objects into the cache. The DMS may perform a requested action on all data objects in the cache.

### FIELD OF TECHNOLOGY

The present disclosure relates generally to data management, including techniques for bulk selection for data management.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports bulk selection for data management in accordance with aspects of the present disclosure.

FIG. 2 shows an example of a system that supports bulk selection for data management in accordance with aspects of the present disclosure.

FIG. 3 shows an example of a process flow that supports bulk selection for data management in accordance with aspects of the present disclosure.

FIG. 4 shows a block diagram of an apparatus that supports bulk selection for data management in accordance with aspects of the present disclosure.

FIG. 5 shows a block diagram of an apparatus that supports bulk selection for data management in accordance with aspects of the present disclosure.

FIG. 6 shows a diagram of a system including a device that supports bulk selection for data management in accordance with aspects of the present disclosure.

FIG. 7 shows a flowchart illustrating methods that support bulk selection for data management in accordance with aspects of the present disclosure.

### DETAILED DESCRIPTION

A data management system (DMS) may manage (e.g., store, include, backup, or otherwise perform operations associated with) a set of data objects. A user may select data objects from the set of data objects and may perform one or more actions on the selected data objects (e.g., deleting, moving, downloading, uploading, editing a domain, recovering, exporting, and the like). The user may perform a same action on many (e.g., all) data objects of the set. In some examples, the user may flag or otherwise indicate that a requested action is to be performed on all data objects of a given set (e.g., all data objects of a table of data objects). However, the set may be stored across multiple databases within a back-end of the DMS, the set may be associated with numerous attributes, or both, and aggregating the requested data in the back-end for each operation may increase latency and processing. The back-end of the DMS may include one or more databases, servers, or the like configured to store data managed by the DMS and operate according to a back-end communication protocol.

Techniques described herein may enable the user to select a relatively large quantity of (e.g., all) data objects of a set and to perform actions on all selected data objects with relatively reduced back-end processing by the DMS. The described techniques may be facilitated by caching and processing the requested data within a front-end interface of the DMS. The front-end of the DMS may include a user interface and one or more other components configured to facilitate user requests by interfacing between the user interface and the back-end of the DMS (e.g., the hardware, databases, servers, and the like). For example, in response to a user request to select all objects of a set, the DMS may load the set of data objects into a cache of the front-end (e.g., associated with or otherwise accessible by the user interface). If the set has less than a threshold quantity of data objects, the DMS may load all data objects of the set into the cache. The user may accordingly perform an action on all data objects of the set and the action may be performed relatively quickly within the front-end (e.g., without retrieving the data in response to each request). Additionally, or alternatively, if the set has more than the threshold quantity of data objects, the DMS may load a first set of the threshold quantity of data objects into the cache. The user may accordingly request that an action is performed on the first set of data objects. After the DMS performs the action, the DMS may automatically prompt the user to provide a second request to select a second set of data objects of the set (e.g., a second set including the threshold quantity of data objects and/or all remaining data objects of the set, if less than the threshold), and the DMS may load the second set of data objects into the cache in response to the second request. The threshold quantity may be a maximum quantity that is supported by a front-end pull operation. The DMS may iteratively perform actions and prompt the user to perform another selection until all of the data objects have been selected, such that the user may effectively perform a “select-all” action while the front-end pull operation protocols are maintained.

In some examples, the user may deselect one or more of the data objects in the cache (e.g., prior to performing the action). In such examples, the frontend may maintain the deselected data objects in the cache, and may perform the requested action on all data objects in the cache excepting the deselected data objects. The described techniques thereby improve performance, reduce processing, and reduce latency as compared with techniques for selecting all data objects and performing operations on the data objects within a back-end of the DMS.

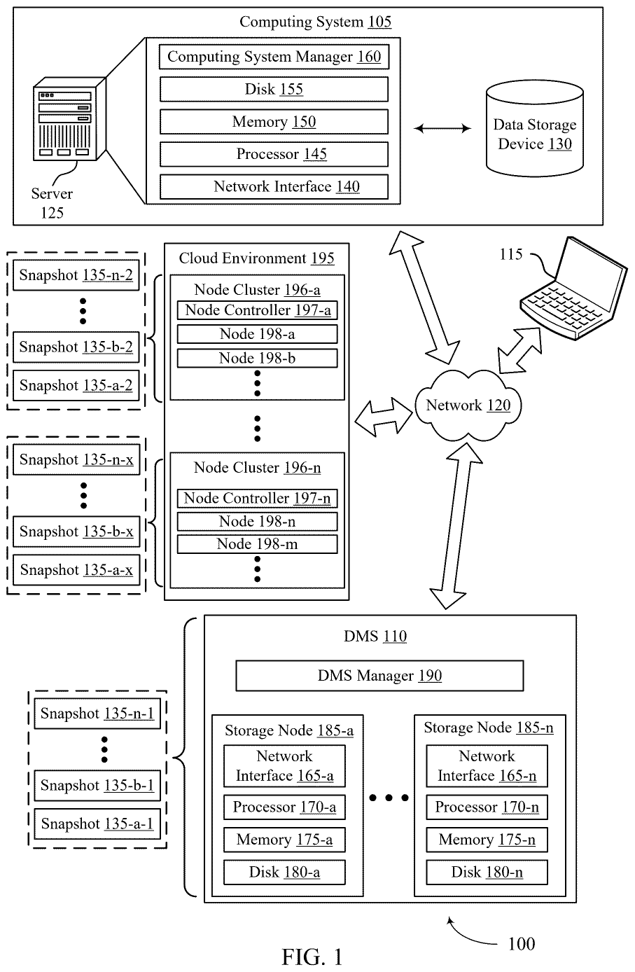

FIG. 1 illustrates an example of a computing environment 100 that supports bulk selection for data management in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120).

IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

In some examples of the computing environment 100, a user of a DMS 110 may select many (e.g., all) data objects of a set to perform actions on all selected data objects with relatively reduced back-end processing. For example, a front-end of the DMS 110 may include a user interface and one or more other components configured to facilitate user requests by interfacing between the user interface and a back-end of the DMS 110. For example, in response to a user request to select all objects of a set, the DMS 110 may load the set of data objects into a cache of the front-end. If the set has less than a threshold quantity of data objects, the DMS 110 may load all data objects of the set into the cache. The user may accordingly perform an action on all data objects of the set.

Additionally, or alternatively, if the set has more than the threshold quantity of data objects, the DMS 110 may load a first set of the threshold quantity of data objects into the cache. The user may accordingly perform an action on the first set of data objects. The DMS 110 may prompt the user to provide a second request to select a second set of data objects of the set (e.g., a second set of the threshold quantity of data objects and/or all remaining data objects of the set), and the DMS 110 may load the second set of data objects into the cache in response to the second request. The threshold quantity may be a maximum quantity that is supported by a front-end pull operation.

In some examples, the user may deselect one or more of the data objects in the cache (e.g., prior to performing the action). In such examples, the frontend may maintain the deselected data objects in the cache, and may perform the requested action on all data objects in the cache excepting the deselected data objects. The described techniques thereby improve performance, reduce processing, and reduce latency as compared with techniques for selecting all data objects and performing operations on the data objects within a back-end of the DMS 110.

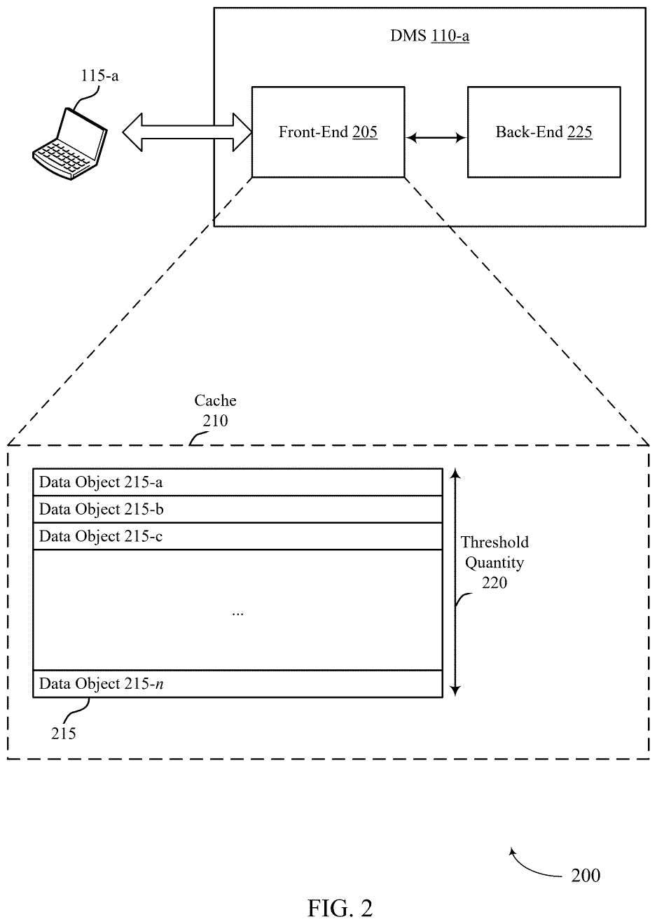

FIG. 2 shows an example of a system 200 that supports bulk selection for data management in accordance with aspects of the present disclosure. The system 200 may implement or may be implemented by aspects of the computing environment 100. For example, the system 200 may be implemented by a DMS 110-a and a computing device 115-a, which may be examples of a DMS 110 and a computing device 115, respectively, as described with reference to FIG. 1.

In some examples of the system 200, a user may use a computing device 115-a to interface with the DMS 110-a, which may manage the user's data. For example, the user may request, via the computing device 115-a, that the DMS 110-a perform one or more data management operations on a set of data objects 215 managed by a DMS 110-a. In some examples, the set of data objects 215 may be viewable by the user via a user interface of the computing device 115-a (e.g., displayed as a table via one or more pages on the user interface). In some examples, the set of data objects may be stored across one or more storage nodes or across multiple databases (e.g., across multiple data tables across the multiple databases) within a back-end 225 of the DMS 110-a. The DMS 110-a described herein may include the front-end 205 and the back-end 225, which may represent groups of layers, components, circuits, hardware, software, or any combination thereof within the DMS 110-a. For example, the back-end 225 may generally refer to (e.g., include) a data access layer within the DMS 110-a, which may include physical infrastructure or hardware configured to facilitate data storage and business logic, among other examples. The front-end 205 may generally refer to (e.g., include) a presentation layer within the DMS 110-a, which may include software, interfaces, circuitry, or the like configured to facilitate communication with a client. In some examples, the front-end 205 may include one or more components that may be manipulated by a user (e.g., accessible by the computing device 115-a), and the back-end 225 may be removed physically from the computing device 115-a (e.g., on one or more servers of the DMS 110-a).

In some examples, the user may want to perform an action on one or more data objects 215 in a set of data objects 215 (e.g., deleting the one or more data objects 215, editing a domain associated with the one or more data objects 215, exporting the one or more data objects 215, recovering the one or more data objects 215, obtaining a snapshot of the one or more data objects 215, or the like). The user may accordingly select the one or more data objects 215 via the user interface. In some examples, the user interface may display an indication to the user that the one or more data objects 215 have been selected. For example, the user interface may display a check mark next to the one or more data objects 215, may highlight the one or more data objects 215, and the like. The user may accordingly request for the DMS 110-a to perform the action on all selected data objects 215.

In some examples, the user may want to perform the action on most (e.g., all) data objects 215 of the set of data objects 215. In such examples, the user may not want to individually select each data object 215 of the set of data objects 215. Accordingly, the DMS 110-a may include an option on the user interface for the user to select all data objects 215 of the set of data objects 215. In some examples, in response to the user selecting all data objects 215 of the set of data objects 215 and indicating an action for the DMS 110-a to perform on the selected data objects 215, the DMS 110-a may provide a flag to the back-end 225 of the DMS 110-a that indicates for the back-end 225 to aggregate all data objects stored across the multiple databases, which may include multiple queries, joins, and data transformations. However, such techniques may result in relatively large processing by the back-end 225 and may result in latency among other computational inefficiencies.

Accordingly, techniques described herein may enable the DMS 110-a to perform an action on all or most data objects 215 of the set of data objects 215 with relatively reduced processing of the back-end 225 by caching data objects and performing actions at a client side interface (e.g., front-end 205). For example, the front-end 205 of the DMS 110-a may include a cache 210 (e.g., a memory) in which the front-end 205 may store the one or more data objects 215. For example, in response to the user input at the user interface to select all data objects 215 (e.g., triggering an action tile, checking a checkbox, selecting a “Select All” button, etc.), the front-end 205 may store at least a subset of the data objects 215 to the cache 210. The user may accordingly indicate for the front-end 205 to perform the action on the data objects 215 in the cache, which may decrease processing for the back-end 225. In some examples, the user interface may update to display an additional action tile (e.g., a “Clear Selection” button).

The user interface may indicate to the user that the at least subset of data objects 215 are selected (e.g., via a check mark next to the one or more data objects 215, may highlight the one or more data objects 215, may provide an explicit message or other indication to the user, and the like). In some examples, the one or more data objects 215 may remain selected (e.g., and stored in the cache 210) as the user navigates the user interface. For example, the user may select an option to view a next page of the set of data objects 215 (e.g., a next X rows of the table of data objects 215). The user interface may accordingly display the next page, which may include displaying an indication that the data objects 215 of the next page are selected. The user may select an option to view a previous page of the set of data objects 215 (e.g., a previous X rows of the table of data objects 215). The user interface may accordingly display the previous page, which may also include displaying an indication that the data objects 215 of the next page are selected.

In some examples, while storing the data objects 215 to the cache 210, the front-end 205 may display a user interface page (e.g., via the user interface of the computing device 115-a) that may prevent the DMS 110-a from receiving one or more inputs or selections from the user. For example, the user interface page may be a mask that prevents the user from making one or more selections on the user interface. The user interface page may include a message (e.g., “Selecting All Objects in All Pages,” “Don't close this page or navigate away,” etc.), an estimated duration of the storage operation (e.g., “This can take up to 5 minutes”), an estimated remaining duration of the storage operation (e.g., “3 minutes remaining”), and the like. In some examples, the DMS 110-a (e.g., the front-end 205) may terminate displaying the user interface page upon completion of the storage operation such that the user may provide one or more inputs (e.g., a request to perform the action).

In some aspects, the cache 210 may be associated with a threshold quantity 220 (e.g., an error trigger quantity) of data objects 215. For example, the front-end 205 may store up to the threshold quantity 220 of data objects 215 in the cache 210 (e.g., and may not store more than the threshold quantity 220 of data objects 215 in the cache 210). The threshold quantity 220 may be associated with a limit of data objects 215 that may be stored by the front-end 205 (e.g., due to performance or functionality constraints), or a limit of data objects 215 that may be pulled at once via a front-end pull from the back-end 225, or both. Such techniques may reduce processing of the front-end 205, which may improve user experience (e.g., by preventing a crash due to an over-full cache, for example). In some examples, the threshold quantity 220 may be configurable for each set of data objects 215 (e.g., for each data table managed by the DMS 110-a).

In examples in which the set of data objects 215 includes a quantity of data objects that is less than or equal to the threshold quantity 220, the DMS 110-a (e.g., the front-end 205) may store all of the data objects 215 in the set of data objects 215 (e.g., a data object 215-a, a data object 215-b, a data object 215-c, and so on through a data object 215-n) to the cache 210 in response to the selection by the user. In examples in which the set of data objects 215 includes a quantity of data objects that is more than the threshold quantity 220 of data objects 215, the DMS 110-a (e.g., the front-end 205) may store the threshold quantity 220 of data objects 215 in the set of data objects 215 (e.g., a subset of the set of data objects 215) to the cache 210 in response to the selection by the user. The front-end 205 may perform the action on the data objects 215 in the cache 210 (e.g., and not on one or more data objects 215 that are not stored in the cache 210).

In examples in which the set of data objects 215 includes a quantity of data objects that is more than the threshold quantity 220 of data objects 215, after performing an action on the subset of the set of data objects 215 to the cache 210, the front-end may display a prompt to the user (e.g., via the user interface) for the user to select an additional subset of the set of data objects 215. For example, the prompt may include a message such as “Select next n objects?” and one or more options (e.g., “Yes” and “No”) selectable by the user to select the additional subset or to dismiss the prompt (e.g., without selecting the additional subset). The user may therefore intuitively select the additional subset in response to the prompt. In some examples, in response to an additional selection by the user, the front-end 205 may store the additional subset to the cache 210. The previously selected objects may be removed from the cache 210 prior to storage of the additional subset, or may otherwise be replaced by the additional subset. In some examples, a quantity of data objects 215 in the additional subset may be less than or equal to the threshold quantity 220. This process may repeat iteratively through one or more rounds until all of the data objects 215 are selected, cached in the front-end 205, and the action is performed on all of the data objects.

In some examples, the user may provide a user input to deselect one or more data objects 215. In such examples, the front-end 205 may maintain the deselected one or more data objects 215 in the cache 210. The front-end 205 may flag the one or more deselected data objects 215 as being deselected via the user interface, and, in response to a request from the user to perform the action, the front-end 205 may not perform the action on the deselected one or more data objects 215 (e.g., despite the deselected one or more data objects 215 being stored in the cache 210). Accordingly, the user may re-select the one or more deselected data objects 215 without the front-end 205 re-storing the deselected one or more data objects 215 to the cache 210.

As an illustrative example, the user may select all data objects 215 (e.g., n data objects 215) of the set of data objects. The user may navigate to a next page of the user interface and deselect 10 data objects 215. The user may navigate to a third page of the user interface and deselect 20 data objects 215. The user may therefore perform an action on the selected n-30 data objects 215 (e.g., and not on the 30 deselected data objects 215).

In some examples, the front-end 205 may maintain the data objects 215 in the cache 210 until the user performs one or more actions to clear the cache 210 (e.g., until the user logs out of the user interface, until the user refreshes the user interface).

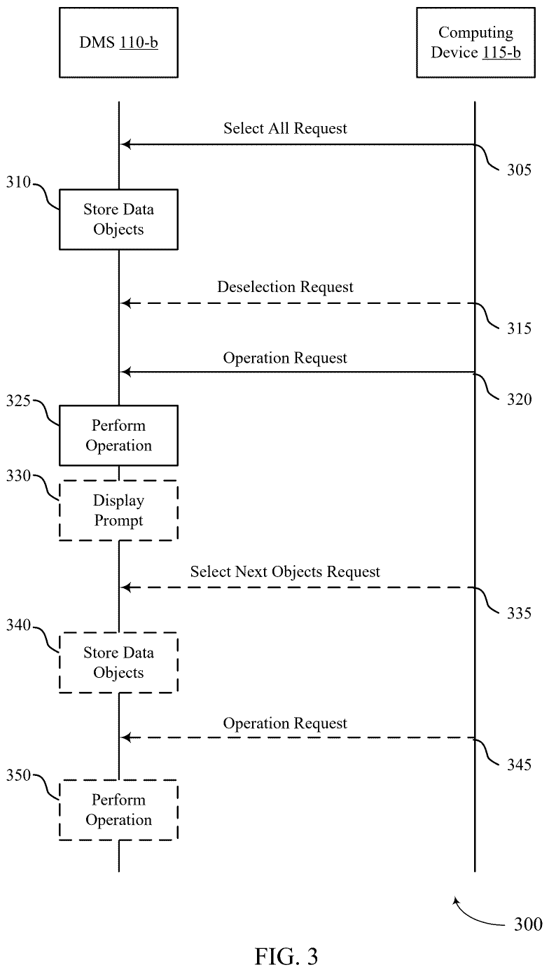

FIG. 3 shows an example of a process flow 300 that supports bulk selection for data management in accordance with aspects of the present disclosure. The process flow 300 may implement or may be implemented by aspects of the computing environment 100, or the system 200. For example, the process flow 300 may be implemented by a DMS 110-b and a computing device 115-b, which may be examples of a DMS 110 and a computing device 115, respectively, as described with reference to FIGS. 1 and 2.

In the following description of the process flow 300, the operations between the DMS 110-b and the computing device 115-b may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 305, a user may provide, via the computing device 115-b, a request for the DMS 110-b to select all data objects of a set (e.g., a table) of data objects stored by the DMS 110-b. For example, the user may provide the request by making a selection at a user interface of a front-end of the DMS 110-b. The set of data objects may be stored in one or more databases within a back-end of the DMS 110-b.

At 310, the DMS 110-b may store at least a subset of the data objects of the set of data objects to a cache within the front-end (e.g., in response to the request). For example, the front-end of the DMS 110-b may retrieve the at least the subset of data objects from the back-end of the DMS 110-b via one or more front-end pull operations. In some examples, if a quantity of data objects of the set of data objects is less than or equal to a threshold quantity, the front-end of the DMS 110-b may store all data objects to the cache. If the quantity of data objects is greater than the threshold quantity, the front-end of the DMS 110-b may store a quantity of data objects equal to the threshold quantity of data objects from the set to the cache. That is, if the quantity of data objects is greater than the threshold quantity, the at least the subset of data objects may include less than all of the data objects in the set.

In some examples, the DMS 110-b may display, via the user interface while storing the subset of data objects to the cache, a user interface page that prevents the DMS 110-b from receiving further inputs via the user interface while storing the subset of data objects. For example, the user interface page may include a mask that prevents the user from providing inputs via the user interface, a message indicating an instruction for the user (e.g., to refrain from leaving or refreshing the user interface page), an estimated duration associated with storing the subset of data objects to the cache, an estimated remaining duration associated with storing the subset of data objects to the cache, and the like. The DMS 110-b may terminate displaying the user interface page in response to completion of storing the subset of data objects to the cache.

In some examples, at 315, the user may provide a request (e.g., via computing device 115-b, via a selection at the user interface) to deselect one or more data objects from the at least the subset of data objects. In such examples, the DMS 110-b may flag the one or more data objects as being deselected (e.g., without removing the deselected one or more data objects from the cache).

At 320, the DMS 110-b may receive a second request from the user (e.g., from the user interface of the front-end, via the computing device 115-b) to perform an action on at least one of the at least subset of the data objects. For example, the action may include deleting the one or more data objects, editing a domain associated with the one or more data objects, exporting the one or more data objects, recovering the one or more data objects, obtaining a snapshot of the one or more data objects, and the like.

At 325, the DMS 110-b (e.g., the front-end of the DMS 110-b) may perform the action in response to the request. For example, the DMS 110-b may perform the action on all data objects of the at least subset of data objects in the cache. In examples in which the user provided a request to deselect one or more data objects, the DMS 110-b may perform the action on all data objects of the at least subset of data objects in the cache except the deselected one or more data objects. That is, the one or more data objects may exclude the deselected one or more data objects.

At 330, in some examples (e.g., if the at least the subset of data objects may include less than all of the data objects in the set), the DMS 110-b may prompt the user (e.g., via the user interface of the front-end) to request for the DMS 110-b to select an additional subset of the set of data objects (e.g., a remaining quantity of data objects of the set of data objects, an additional threshold quantity of the set of data objects). In such examples, at 335, the user may provide a third user input (e.g., via the user interface, via the computing device 115-b) to select the additional subset (e.g., in response to the prompt).

At 340, the DMS 110-b may store the additional subset of the data objects of the set of data objects to a cache within the front-end (e.g., in response to the request). In some examples, the DMS 110-b may display, via the user interface while storing the subset of data objects to the cache, the user interface page that prevents the DMS 110-b from receiving further inputs via the user interface while storing the subset of data objects.

At 345, the DMS 110-b may receive a fourth request from the user (e.g., from the user interface of the front-end, via the computing device 115-b) to perform an action on at least one of the additional subset of the data objects. For example, the action may include deleting the one or more data objects, editing a domain associated with the one or more data objects, exporting the one or more data objects, recovering the one or more data objects, obtaining a snapshot of the one or more data objects, and the like. At 350, the DMS 110-b (e.g., the front-end of the DMS 110-b) may perform the action in response to the request. Additionally, or alternatively, the DMS 110-b may not receive a second request at 345, and the DMS 110-b may perform the action on the additional subset of data objects in response to the request received at 320 and in response to moving the additional subset of data objects to the cache after the request at 335.

The DMS 110-b may thereby support improved “select-all” operations with reduced latency and improved efficiency as compared with other “select-all” operations in which the DMS 110-b aggregates all data objects within a back-end of the DMS 110-b before performing any operation. For example, by pulling the selected data objects to a front-end cache in response to a select-all request, the DMS 110-b may reduce backend aggregation operations, reduce latency, and provide for a more efficient method for performing an operation on all of the selected data objects. Additionally, the use of the threshold described herein may ensure that the front-end does not crash and is able to handle the additional data objects.

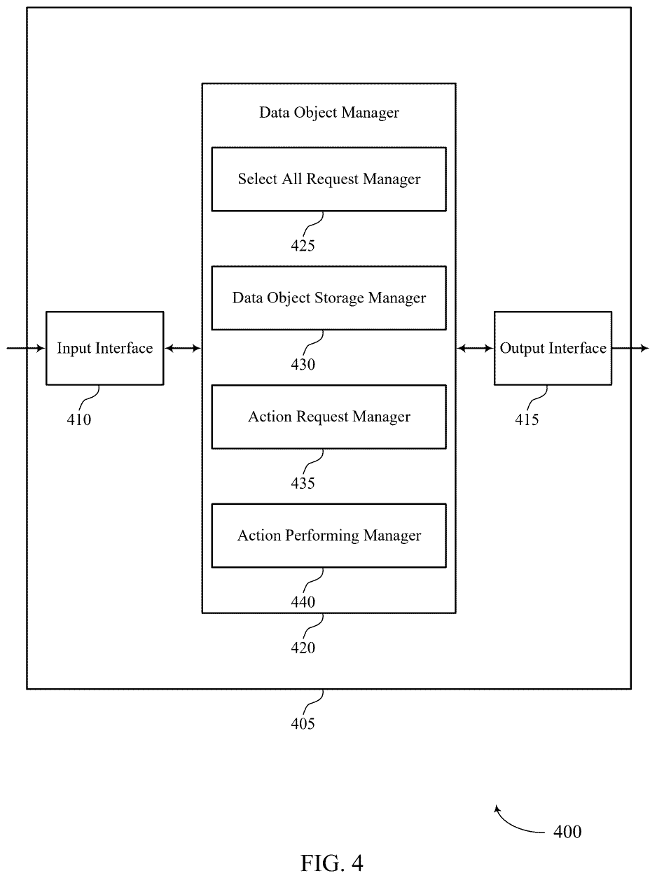

FIG. 4 shows a block diagram 400 of a system 405 that supports bulk selection for data management in accordance with aspects of the present disclosure. In some examples, the system 405 may be an example of aspects of one or more components described with reference to FIG. 1, such as a DMS 110. The system 405 may include an input interface 410, an output interface 415, and a data object manager 420. The system 405 may also include one or more processors. Each of these components may be in communication with one another (e.g., via one or more buses, communications links, communications interfaces, or any combination thereof).

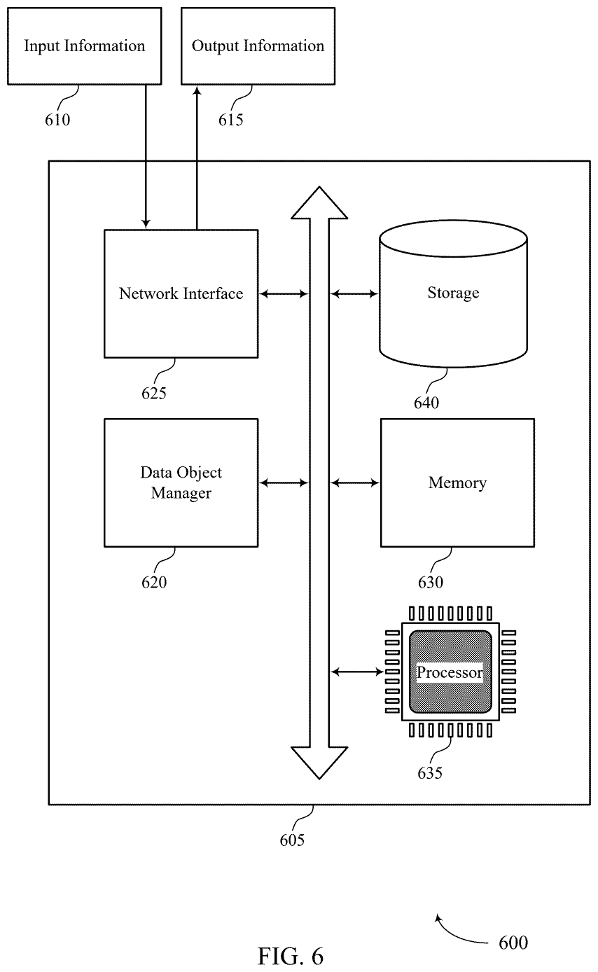

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the data object manager 420 to support bulk selection for data management. In some cases, the input interface 410 may be a component of a network interface 625 as described with reference to FIG. 6.

The output interface 415 may manage output signaling for the system 405. For example, the output interface 415 may receive signaling from other components of the system 405, such as the data object manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the data object manager 420 may include a select all request manager 425, a data object storage manager 430, an action request manager 435, an action performing manager 440, or any combination thereof. In some examples, the data object manager 420, or various components thereof, may be configured to perform various operations (e.g., receiving, monitoring, transmitting) using or otherwise in cooperation with the input interface 410, the output interface 415, or both. For example, the data object manager 420 may receive information from the input interface 410, send information to the output interface 415, or be integrated in combination with the input interface 410, the output interface 415, or both to receive information, transmit information, or perform various other operations as described herein.

The data object manager 420 may support data management in accordance with examples as disclosed herein. The select all request manager 425 may be configured as or otherwise support a means for receiving, at a user interface of a front-end of a data management system, a first request to select all data objects included in a set of data objects stored by the data management system, the set of data objects stored in one or more databases within a back-end of the data management system. The data object storage manager 430 may be configured as or otherwise support a means for storing, in response to the first request, at least a subset of data objects from among the set of data objects to a cache within the front-end of the data management system. The action request manager 435 may be configured as or otherwise support a means for receiving a second request to perform an action on one or more data objects of the set of data objects. The action performing manager 440 may be configured as or otherwise support a means for performing, by the data management system in response to the second request, the action on the one or more data objects of the subset of data objects stored in the cache, where the action is performed within the cache in accordance with storing the subset of data objects in the cache.

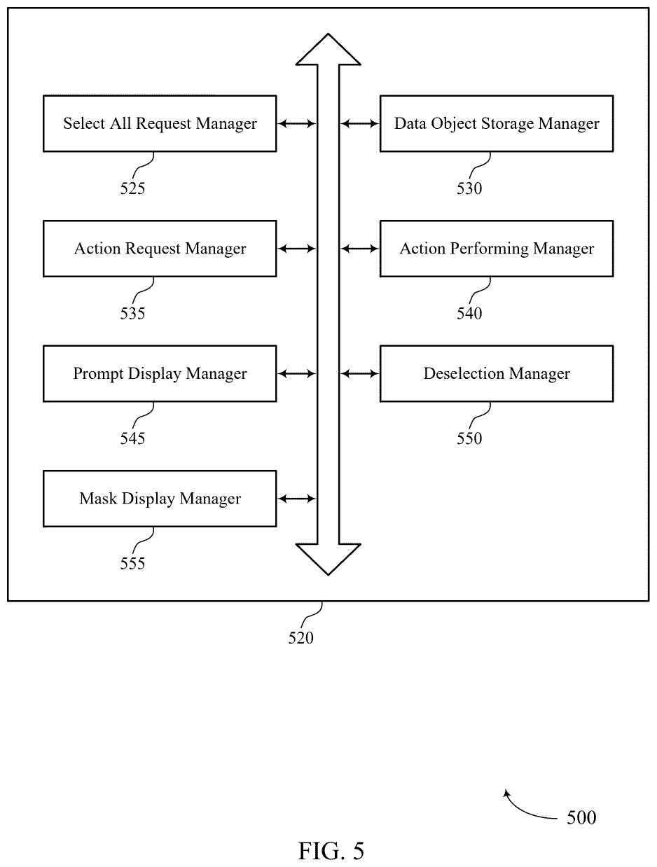

FIG. 5 shows a block diagram 500 of a data object manager 520 that supports bulk selection for data management in accordance with aspects of the present disclosure. The data object manager 520 may be an example of aspects of a data object manager or a data object manager 420, or both, as described herein. The data object manager 520, or various components thereof, may be an example of means for performing various aspects of bulk selection for data management as described herein. For example, the data object manager 520 may include a select all request manager 525, a data object storage manager 530, an action request manager 535, an action performing manager 540, a prompt display manager 545, a deselection manager 550, a mask display manager 555, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The data object manager 520 may support data management in accordance with examples as disclosed herein. The select all request manager 525 may be configured as or otherwise support a means for receiving, at a user interface of a front-end of a data management system, a first request to select all data objects included in a set of data objects stored by the data management system, the set of data objects stored in one or more databases within a back-end of the data management system. The data object storage manager 530 may be configured as or otherwise support a means for storing, in response to the first request, at least a subset of data objects from among the set of data objects to a cache within the front-end of the data management system. The action request manager 535 may be configured as or otherwise support a means for receiving a second request to perform an action on one or more data objects of the set of data objects. The action performing manager 540 may be configured as or otherwise support a means for performing, by the data management system in response to the second request, the action on the one or more data objects of the subset of data objects stored in the cache, where the action is performed within the cache in accordance with storing the subset of data objects in the cache.

In some examples, to support storing at least the subset of data objects to the cache, the data object storage manager 530 may be configured as or otherwise support a means for storing all of the data objects of the set of data objects to the cache based on a quantity of data objects of the set of data objects being less than or equal to a threshold quantity.

In some examples, to support storing at least the subset of data objects to the cache, the data object storage manager 530 may be configured as or otherwise support a means for storing the subset of data objects to the cache based on a quantity of data objects of the set of data objects being greater than a threshold quantity of data objects, where the subset of data objects includes the threshold quantity of data objects selected from among the set of data objects stored by the data management system. In some examples, to support storing at least the subset of data objects to the cache, the prompt display manager 545 may be configured as or otherwise support a means for displaying, via the user interface after performing the action and based on the quantity of data objects of the set of data objects being greater than the threshold quantity, a prompt for a user to provide a third request to select a second subset of data objects of the set of data objects.

In some examples, the select all request manager 525 may be configured as or otherwise support a means for receiving the third request to select the second subset of data objects included in the set of data objects based on displaying the prompt, where a second quantity of data objects of the second subset of data objects is less than or equal to the threshold quantity. In some examples, the data object storage manager 530 may be configured as or otherwise support a means for storing, in response to the third request, the second subset of data objects to the cache.

In some examples, the action request manager 535 may be configured as or otherwise support a means for receiving a fourth request to perform the action on one or more second data objects of the second subset of data objects. In some examples, the action performing manager 540 may be configured as or otherwise support a means for performing, by the data management system in response to the second request, the action on the one or more second data objects of the second subset of data objects stored in the cache, where the action is performed within the cache in accordance with storing the second subset of data objects in the cache.

In some examples, the deselection manager 550 may be configured as or otherwise support a means for receiving a user input requesting to deselect at least one data object of the set of data objects, where the one or more data objects on which the action is performed exclude the at least one data object in accordance with the user input.

In some examples, the mask display manager 555 may be configured as or otherwise support a means for displaying, via the user interface and while storing the subset of data objects to the cache, a user interface page that prevents receipt of one or more inputs via the user interface while storing the subset of data objects to the cache. In some examples, the mask display manager 555 may be configured as or otherwise support a means for terminating the display of the user interface page after storing the subset of data objects to the cache.

In some examples, the user interface page includes a message indicating an instruction for a user, an estimated duration associated with storing the subset of data objects to the cache, an estimated remaining duration associated with storing the subset of data objects to the cache, or any combination thereof.

In some examples, the action includes deleting the one or more data objects, editing a domain associated with the one or more data objects, exporting the one or more data objects, recovering the one or more data objects, obtaining a snapshot of the one or more data objects, or any combination thereof.

FIG. 6 shows a block diagram 600 of a system 605 that supports bulk selection for data management in accordance with aspects of the present disclosure. The system 605 may be an example of or include components of a system 405 as described herein. The system 605 may include components for data management, including components such as a data object manager 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting bulk selection for data management). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

The data object manager 620 may support data management in accordance with examples as disclosed herein. For example, the data object manager 620 may be configured as or otherwise support a means for receiving, at a user interface of a front-end of a data management system, a first request to select all data objects included in a set of data objects stored by the data management system, the set of data objects stored in one or more databases within a back-end of the data management system. The data object manager 620 may be configured as or otherwise support a means for storing, in response to the first request, at least a subset of data objects from among the set of data objects to a cache within the front-end of the data management system. The data object manager 620 may be configured as or otherwise support a means for receiving a second request to perform an action on one or more data objects of the set of data objects. The data object manager 620 may be configured as or otherwise support a means for performing, by the data management system in response to the second request, the action on the one or more data objects of the subset of data objects stored in the cache, where the action is performed within the cache in accordance with storing the subset of data objects in the cache.

By including or configuring the data object manager 620 in accordance with examples as described herein, the system 605 may support techniques for bulk selection for data management, which may provide one or more benefits such as, for example improved user experience and more efficient utilization of computing resources, network resources or both, among other possibilities.

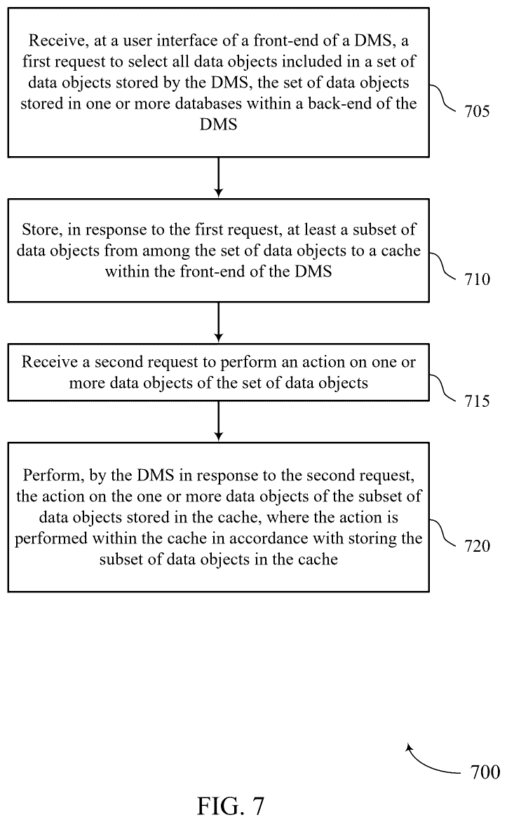

FIG. 7 shows a flowchart illustrating a method 700 that supports bulk selection for data management in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include receiving, at a user interface of a front-end of a data management system, a first request to select all data objects included in a set of data objects stored by the data management system, the set of data objects stored in one or more databases within a back-end of the data management system. The operations of 705 may be performed in accordance with examples as disclosed herein. In some examples, aspects of the operations of 705 may be performed by a select all request manager 525 as described with reference to FIG. 5.

At 710, the method may include storing, in response to the first request, at least a subset of data objects from among the set of data objects to a cache within the front-end of the data management system. The operations of 710 may be performed in accordance with examples as disclosed herein. In some examples, aspects of the operations of 710 may be performed by a data object storage manager 530 as described with reference to FIG. 5.

At 715, the method may include receiving a second request to perform an action on one or more data objects of the set of data objects. The operations of 715 may be performed in accordance with examples as disclosed herein. In some examples, aspects of the operations of 715 may be performed by an action request manager 535 as described with reference to FIG. 5.

At 720, the method may include performing, by the data management system in response to the second request, the action on the one or more data objects of the subset of data objects stored in the cache, where the action is performed within the cache in accordance with storing the subset of data objects in the cache. The operations of 720 may be performed in accordance with examples as disclosed herein. In some examples, aspects of the operations of 720 may be performed by an action performing manager 540 as described with reference to FIG. 5.

The following provides an overview of aspects of the present disclosure:
Aspect 1: A method for data management, comprising: receiving, at a user interface of a front-end of a data management system, a first request to select all data objects included in a set of data objects stored by the data management system, the set of data objects stored in one or more databases within a back-end of the data management system; storing, in response to the first request, at least a subset of data objects from among the set of data objects to a cache within the front-end of the data management system; receiving a second request to perform an action on one or more data objects of the set of data objects; and performing, by the data management system in response to the second request, the action on the one or more data objects of the subset of data objects stored in the cache, wherein the action is performed within the cache in accordance with storing the subset of data objects in the cache.
Aspect 2: The method of aspect 1, wherein storing at least the subset of data objects to the cache comprises: storing all of the data objects of the set of data objects to the cache based at least in part on a quantity of data objects of the set of data objects being less than or equal to a threshold quantity.
Aspect 3: The method of aspect 1, wherein storing at least the subset of data objects to the cache comprises: storing the subset of data objects to the cache based at least in part on a quantity of data objects of the set of data objects being greater than a threshold quantity of data objects, wherein the subset of data objects comprises the threshold quantity of data objects selected from among the set of data objects stored by the data management system; and displaying, via the user interface after performing the action and based at least in part on the quantity of data objects of the set of data objects being greater than the threshold quantity, a prompt for a user to provide a third request to select a second subset of data objects of the set of data objects.
Aspect 4: The method of aspect 3, further comprising: receiving the third request to select the second subset of data objects included in the set of data objects based at least in part on displaying the prompt, wherein a second quantity of data objects of the second subset of data objects is less than or equal to the threshold quantity; and storing, in response to the third request, the second subset of data objects to the cache.
Aspect 5: The method of aspect 4, further comprising: receiving a fourth request to perform the action on one or more second data objects of the second subset of data objects; and performing, by the data management system in response to the second request, the action on the one or more second data objects of the second subset of data objects stored in the cache, wherein the action is performed within the cache in accordance with storing the second subset of data objects in the cache.
Aspect 6: The method of any of aspects 1 through 5, further comprising: receiving a user input requesting to deselect at least one data object of the set of data objects, wherein the one or more data objects on which the action is performed exclude the at least one data object in accordance with the user input.
Aspect 7: The method of any of aspects 1 through 6, further comprising: displaying, via the user interface and while storing the subset of data objects to the cache, a user interface page that prevents receipt of one or more inputs via the user interface while storing the subset of data objects to the cache; and terminating the display of the user interface page after storing the subset of data objects to the cache.
Aspect 8: The method of aspect 7, wherein the user interface page comprises a message indicating an instruction for a user, an estimated duration associated with storing the subset of data objects to the cache, an estimated remaining duration associated with storing the subset of data objects to the cache, or any combination thereof.
Aspect 9: The method of any of aspects 1 through 8, wherein the action comprises deleting the one or more data objects, editing a domain associated with the one or more data objects, exporting the one or more data objects, recovering the one or more data objects, obtaining a snapshot of the one or more data objects, or any combination thereof.
Aspect 10: An apparatus for data management, comprising one or more memories storing processor-executable code, and one or more processors coupled with the one or more memories and individually or collectively operable to execute the code to cause the apparatus to perform a method of any of aspects 1 through 9.
Aspect 11: An apparatus for data management, comprising at least one means for performing a method of any of aspects 1 through 9.
Aspect 12: A non-transitory computer-readable medium storing code for data management, the code comprising instructions executable by one or more processors to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for data management, comprising:
receiving, at a user interface of a front-end of a data management system, a first request to select all data objects included in a set of data objects stored by the data management system, the set of data objects stored in one or more databases within a back-end of the data management system;
storing, in response to the first request, at least a subset of data objects from among the set of data objects to a cache within the front-end of the data management system;
receiving a second request to perform an action on one or more data objects of the set of data objects; and
performing, by the data management system in response to the second request, the action on the one or more data objects of the subset of data objects stored in the cache, wherein the action is performed within the cache in accordance with storing the subset of data objects in the cache.

2. The method of claim 1, wherein storing at least the subset of data objects to the cache comprises:
storing all of the data objects of the set of data objects to the cache based at least in part on a quantity of data objects of the set of data objects being less than or equal to a threshold quantity.

3. The method of claim 1, wherein storing at least the subset of data objects to the cache comprises:
storing the subset of data objects to the cache based at least in part on a quantity of data objects of the set of data objects being greater than a threshold quantity of data objects, wherein the subset of data objects comprises the threshold quantity of data objects selected from among the set of data objects stored by the data management system; and
displaying, via the user interface after performing the action and based at least in part on the quantity of data objects of the set of data objects being greater than the threshold quantity, a prompt for a user to provide a third request to select a second subset of data objects of the set of data objects.

4. The method of claim 3, further comprising:
receiving the third request to select the second subset of data objects included in the set of data objects based at least in part on displaying the prompt, wherein a second quantity of data objects of the second subset of data objects is less than or equal to the threshold quantity; and
storing, in response to the third request, the second subset of data objects to the cache.

5. The method of claim 4, further comprising:
receiving a fourth request to perform the action on one or more second data objects of the second subset of data objects; and
performing, by the data management system in response to the second request, the action on the one or more second data objects of the second subset of data objects stored in the cache, wherein the action is performed within the cache in accordance with storing the second subset of data objects in the cache.

6. The method of claim 1, further comprising:
receiving a user input requesting to deselect at least one data object of the set of data objects, wherein the one or more data objects on which the action is performed exclude the at least one data object in accordance with the user input.

7. The method of claim 1, further comprising:
displaying, via the user interface and while storing the subset of data objects to the cache, a user interface page that prevents receipt of one or more inputs via the user interface while storing the subset of data objects to the cache; and
terminating the display of the user interface page after storing the subset of data objects to the cache.

8. The method of claim 7, wherein the user interface page comprises a message indicating an instruction for a user, an estimated duration associated with storing the subset of data objects to the cache, an estimated remaining duration associated with storing the subset of data objects to the cache, or any combination thereof.

9. The method of claim 1, wherein the action comprises deleting the one or more data objects, editing a domain associated with the one or more data objects, exporting the one or more data objects, recovering the one or more data objects, obtaining a snapshot of the one or more data objects, or any combination thereof.

10. An apparatus for data management, comprising:
one or more memories storing processor-executable code; and
one or more processors coupled with the one or more memories and individually or collectively operable to execute the code to cause the apparatus to:
receive, at a user interface of a front-end of a data management system, a first request to select all data objects included in a set of data objects stored by the data management system, the set of data objects stored in one or more databases within a back-end of the data management system;
store, in response to the first request, at least a subset of data objects from among the set of data objects to a cache within the front-end of the data management system;
receive a second request to perform an action on one or more data objects of the set of data objects; and
perform, by the data management system in response to the second request, the action on the one or more data objects of the subset of data objects stored in the cache, wherein the action is performed within the cache in accordance with storing the subset of data objects in the cache.

11. The apparatus of claim 10, wherein, to store at least the subset of data objects to the cache, the one or more processors are individually or collectively operable to execute the code to cause the apparatus to:
store all of the data objects of the set of data objects to the cache based at least in part on a quantity of data objects of the set of data objects being less than or equal to a threshold quantity.

12. The apparatus of claim 10, wherein, to store at least the subset of data objects to the cache, the one or more processors are individually or collectively operable to execute the code to cause the apparatus to:
store the subset of data objects to the cache based at least in part on a quantity of data objects of the set of data objects being greater than a threshold quantity of data objects, wherein the subset of data objects comprises the threshold quantity of data objects selected from among the set of data objects stored by the data management system; and
display, via the user interface after performing the action and based at least in part on the quantity of data objects of the set of data objects being greater than the threshold quantity, a prompt for a user to provide a third request to select a second subset of data objects of the set of data objects.

13. The apparatus of claim 12, wherein the one or more processors are individually or collectively further operable to execute the code to cause the apparatus to:
receive the third request to select the second subset of data objects included in the set of data objects based at least in part on displaying the prompt, wherein a second quantity of data objects of the second subset of data objects is less than or equal to the threshold quantity; and
store, in response to the third request, the second subset of data objects to the cache.

14. The apparatus of claim 13, wherein the one or more processors are individually or collectively further operable to execute the code to cause the apparatus to:
receive a fourth request to perform the action on one or more second data objects of the second subset of data objects; and
perform, by the data management system in response to the second request, the action on the one or more second data objects of the second subset of data objects stored in the cache, wherein the action is performed within the cache in accordance with storing the second subset of data objects in the cache.

15. The apparatus of claim 10, wherein the one or more processors are individually or collectively further operable to execute the code to cause the apparatus to:
receive a user input requesting to deselect at least one data object of the set of data objects, wherein the one or more data objects on which the action is performed exclude the at least one data object in accordance with the user input.

16. The apparatus of claim 10, wherein the one or more processors are individually or collectively further operable to execute the code to cause the apparatus to:
display, via the user interface and while storing the subset of data objects to the cache, a user interface page that prevents receipt of one or more inputs via the user interface while storing the subset of data objects to the cache; and
terminate the display of the user interface page after storing the subset of data objects to the cache.

17. The apparatus of claim 16, wherein the user interface page comprises a message indicating an instruction for a user, an estimated duration associated with storing the subset of data objects to the cache, an estimated remaining duration associated with storing the subset of data objects to the cache, or any combination thereof.

18. The apparatus of claim 10, wherein the action comprises deleting the one or more data objects, editing a domain associated with the one or more data objects, exporting the one or more data objects, recovering the one or more data objects, obtaining a snapshot of the one or more data objects, or any combination thereof.

19. A non-transitory computer-readable medium storing code for data management, the code comprising instructions executable by one or more processors to:
receive, at a user interface of a front-end of a data management system, a first request to select all data objects included in a set of data objects stored by the data management system, the set of data objects stored in one or more databases within a back-end of the data management system;
store, in response to the first request, at least a subset of data objects from among the set of data objects to a cache within the front-end of the data management system;
receive a second request to perform an action on one or more data objects of the set of data objects; and
perform, by the data management system in response to the second request, the action on the one or more data objects of the subset of data objects stored in the cache, wherein the action is performed within the cache in accordance with storing the subset of data objects in the cache.

20. The non-transitory computer-readable medium of claim 19, wherein the instructions to store at least the subset of data objects to the cache are executable by the one or more processors to:
store all of the data objects of the set of data objects to the cache based at least in part on a quantity of data objects of the set of data objects being less than or equal to a threshold quantity.
